(19) United States
(12) Patent Application Publication
(10) Pub. No.: US 2024/0170818 A1
(43) Pub. Date: May 23, 2024

(54) BATTERY CELL AND BATTERY DEVICE INCLUDING BATTERY CELL

(71) Applicant: SK ON CO., LTD., Seoul (KR)

(72) Inventors: John Cronin, Jericho, VT (US); Hye Been SON, Daejeon (KR); Soo Min PARK, Daejeon (KR); Hyung Ju PAIK, Daejeon (KR); Hae Ryong JEON, Daejeon (KR)

(21) Appl. No.: 18/360,819

(22) Filed: Jul. 28, 2023

Related U.S. Application Data
(60) Provisional application No. 63/427,658, filed on Nov. 23, 2022.

(51) Int. Cl. H01M 50/581; H01M 10/42; H01M 50/209; H02J 7/00

(52) U.S. Cl. CPC H01M 50/581; H01M 10/425; H01M 50/209; H02J 7/007194; H01M 2010/4278; H01M 2200/103

(57) ABSTRACT

A battery cell includes an electrode assembly including an electrode foil; an electrode terminal electrically connected to the electrode foil; and a thermal fuse coupled to the electrode terminal and deformable at a set temperature or higher, wherein the thermal fuse is configured to block a current flow between the electrode terminal and outside of the plurality of battery cells at a set temperature or higher.

### CROSS-REFERENCE TO RELATED APPLICATION(S)

This patent document claims the benefit of U.S. Provisional Patent Application No. 63/427,658 filed on Nov. 23, 2022, the disclosure of which is incorporated herein by reference in its entirety.

### TECHNICAL FIELD

The technology and implementations disclosed in this patent document generally relate to a battery cell capable of being charged with and discharged of electricity, and more particularly, to a battery cell capable of increasing safe operation and a battery device including the same.

### BACKGROUND

Battery cells may have issues with a temperature rise when excessive heat and pressure builds up inside a can (case) thereof. An increase in battery cell temperature may compromise the functional safety and reliability of battery cells.

In addition, when various events occur, such as when a battery cell reaches the end of a lifespan thereof, when a swelling phenomenon occurs in a battery cell, when an overcharge occurs in a battery cell, when a battery cell is exposed to heat, when a sharp object such as a nail penetrates the case of a battery cell, and when an external shock is applied to a battery cell, the temperature of the battery cell may increase, and a fire may accordingly occur. A flame or high-temperature gas ejected from a battery cell may cause chain ignition of other, adjacent battery cells accommodated in a battery device.

### SUMMARY

The disclosed technology can be implemented in some embodiments to provide a battery cell capable of blocking or limiting the flow of current flowing through the battery cell when the temperature of the battery cell increases.

In addition, the disclosed technology can be implemented in some embodiments to provide a battery cell capable of delaying or reducing thermal runaway in which flames are sequentially propagated from a battery cell having increased temperature to an adjacent battery cell, and a battery device including the same.

In some embodiments of the disclosed technology, a battery cell includes an electrode assembly including an electrode foil; an electrode terminal electrically connected to the electrode foil; and a thermal fuse coupled to the electrode terminal and deformable at a set temperature or higher, wherein the thermal fuse is configured to block a current flow between the electrode terminal and outside of the battery cell at a set temperature or higher.

In embodiments, the thermal fuse may include a first portion including at least one of a material that melts at a set temperature or higher, a material that boils off at a set temperature or higher, and a material that blows up at a set temperature or higher.

In embodiments, the thermal fuse may further include a second portion and a third portion disposed on both sides of the first portion with respect to a current flow direction, and the second portion and the third portion may be electrically conductive.

In embodiments, the thermal fuse may further include a non-conductive side surface disposed around the first portion.

In embodiments, the thermal fuse may be integrally coupled to the electrode terminal.

The battery cell according to one embodiment may further include a case accommodating the electrode assembly; and a cap plate covering the case, wherein the electrode terminal may be disposed on the cap plate.

In embodiments, the electrode terminal may include a first terminal body having at least a portion disposed externally of the case, and a second terminal body having at least a portion disposed in the case and electrically connecting the electrode foil to the first terminal body, and the thermal fuse may be integrally coupled to at least one of the first terminal body and the second terminal body, or may be disposed between the first terminal body and the second terminal body.

In embodiments, the electrode terminal may include a terminal body of which at least a portion is disposed externally of the case, and the thermal fuse may be installed to be detachable from the terminal body.

In embodiments, the terminal body may include a first plate and a second plate spaced apart from the first plate, and includes a fuse accommodating space configured to accommodate the thermal fuse between the first plate and the second plate, and the first plate and the second plate may be electrically conductive.

In embodiments, the terminal body may further include a plurality of side plates connecting the first plate to the second plate, and the plurality of side plates are non-conductive.

In embodiments, the thermal fuse may be provided as a connector-type thermal fuse coupled to the electrode terminal to supply a current from the electrode terminal externally.

In embodiments, the connector-type thermal fuse may include a first portion including at least one of a material that melts at a set temperature or higher, a material that boils off at a set temperature or higher, and a material that blows up at a set temperature or higher, a second portion connecting the first portion to an external circuit, and a third portion connecting the first portion to the electrode terminal, and the second portion and the third portion may be electrically conductive.

In embodiments, the connector-type thermal fuse may further include a non-conductive side surface disposed around the first portion to cut off an electrical connection between the second portion to the third portion.

In embodiments, the second portion may be exposed externally of the electrode terminal, and the third portion may be disposed to be recessed into the electrode terminal or to be seated on an external surface of the electrode terminal.

In embodiments, the thermal fuse may be provided as a clamp-type thermal fuse configured to clamp the electrode terminal to supply a current from the electrode terminal externally.

In embodiments, the clamp-type thermal fuse may include a first portion including at least one of a material that melts at a set temperature or higher, a material that boils off at a set temperature or higher, and a material that blows up at a set temperature or higher, a second portion connecting the first portion to an external circuit, and a third portion connecting the first portion to the electrode terminal, the second portion and the third portion may be electrically conductive, and the third portion may include a space for accommodating the electrode terminal to clamp the electrode terminal.

In embodiments, the clamp-type thermal fuse may include a non-conductive side surface disposed around the first portion to cut off an electrical connection between the second portion to the third portion.

In embodiments, the electrode terminal and the electrode foil are connected to each other by a current collector.

In embodiments, the electrode terminal may include an anode terminal and a cathode terminal, and the thermal fuse may be disposed on at least one of the anode terminal and the cathode terminal.

In some embodiments of the disclosed technology, a battery device includes a plurality of battery cells; a housing accommodating the plurality of battery cells; and a controller connected to at least one of the plurality of battery cells, wherein the plurality of battery cells include an electrode assembly including an electrode foil, an electrode terminal electrically connected to the electrode foil, and a thermal fuse coupled to the electrode terminal and deformable at a set temperature or higher, wherein the thermal fuse is configured to block a current flow between the electrode terminal and outside of the plurality of battery cells at a set temperature or higher, and wherein, when at least one of current and voltage is not sensed from at least one battery cell among the plurality of battery cells, the controller outputs an abnormal signal or blocks or limits operation of at least a portion of the battery cells.

According to one embodiment, when the temperature of a battery cell increases, the current flow of the battery cell may be blocked or limited through a thermal fuse, thereby improving the stability of the battery cell. Also, the thermal fuse may operate according to an increase in the temperature of at least one of the plurality of battery cell, thereby being able to stably cope with an increase in temperature caused by other factors such as overheating and the like in addition to overcurrent.

According to one embodiment, an increase in the temperature of some battery cells may be sensed, such that the some battery cells having increased temperature may be controlled, thereby improving the stability of a battery device.

According to one embodiment, thermal runaway in which flames are sequentially propagated from a battery cell having increased temperature to an adjacent battery cell may be delayed or reduced.

### BRIEF DESCRIPTION OF DRAWINGS

Certain aspects, features, and advantages of the disclosed technology are illustrated by the following detailed description with reference to the accompanying drawings.

FIG. 1 is an exploded perspective view of a battery cell according to one embodiment.

FIGS. 2A, 2B, and 2C are views for illustrating a top cap assembly according to one embodiment.

FIGS. 3A to 3F are a view for illustrating an assembly process of a top cap assembly and an electrode assembly according to one embodiment.

FIGS. 4A to 4F are a view for illustrating an assembly process of an electrode assembly, a jelly roll bag, and a can according to one embodiment.

FIG. 5A is a perspective view of an electrode assembly including an electrode foil, according to one embodiment.

FIG. 5B is a perspective view illustrating a connection between an electrode foil and an electrode terminal on a top cap assembly, according to one embodiment.

FIGS. 6A and 6B are schematic views illustrating a function of a thermal fuse, wherein FIG. 6A is a schematic view illustrating a conductive state of a thermal fuse and FIG. 6B is a schematic view illustrating a non-conductive state of the thermal fuse.

FIGS. 7A, 7B, and 7C illustrate a thermal fuse integrated into an electrode terminal, wherein FIG. 7A is a perspective view illustrating an electrode terminal, FIGS. 7B and 7C are cross-sectional views taken along line I-I′ in FIG. 7A, illustrating a conductive state and a non-conductive state of the thermal fuse, respectively.

FIG. 8A is a perspective view illustrating a battery cell according to one embodiment.

FIG. 8B is a cross-sectional view taken along line II-II′ in FIG. 8A.

FIG. 9 is a cross-sectional view illustrating a battery cell illustrating a modified example in FIG. 8B.

FIGS. 10A, 10B and 10C illustrate a replaceable thermal fuse, wherein FIG. 10A is a perspective view illustrating a state before the replaceable thermal fuse is coupled to an electrode terminal, FIG. 10B is a perspective view illustrating a state in which the replaceable thermal fuse is coupled to the electrode terminal, and FIG. 10C is a cross-sectional view taken along line in FIG. 10B.

FIG. 11 is a perspective view illustrating a structure in which a connector-type thermal fuse is coupled to an electrode terminal of a battery cell according to one embodiment.

FIG. 12A is a partially cut-away perspective view schematically illustrating a portion in which an electrode terminal and a connector-type thermal fuse are coupled to each other in FIG. 11.

FIGS. 12B and 12C are cross-sectional views taken along the line IV-IV′ in FIG. 12A, each illustrating a conductive state and a non-conductive state of a connector-type thermal fuse.

FIG. 13 is a cross-sectional view taken along the line V-V′ in FIG. 11.

FIGS. 14A, 14B, 14C and 14D are cross-sectional views illustrating a modified example of the battery cell illustrated in FIG. 13.

FIGS. 15A and 15B are schematic views illustrating a clamp-type thermal fuse according to one embodiment, wherein FIG. 15A is a partially cut-away perspective view illustrating a state before the clamp-type thermal fuse is coupled to an electrode terminal, and FIG. 15B is a partially cut-away perspective view illustrating a non-conductive state of a clamp-type thermal fuse in a state in which a clamp-type thermal fuse and an electrode terminal are coupled to each other.

FIG. 16 is a schematic view illustrating a battery device according to one embodiment.

### DETAILED DESCRIPTION

Features of the disclosed technology disclosed in this patent document are described by example embodiments with reference to the accompanying drawings.

Embodiments of the disclosed technology will be more fully described below with reference to the accompanying drawings, and like numbers indicate like elements throughout the several views, and example embodiments are illustrated. However, embodiments of the claims may be implemented in many different forms and are not limited to the embodiments described herein. The examples given herein are non-limiting and only examples among other possible examples.

In the following description, ‘including’ a certain element means that other elements may be further included, rather than excluding other elements unless otherwise stated.

In addition, terms including ordinal numbers such as “first” and “second” used in this specification may be used to describe various components, and the components are not limited by the terms. These terms are only used for the purpose of distinguishing one component from another. For example, a first component may be termed a second component without departing from the scope of the disclosed technology, and similarly, the second element may also be termed the first element.

It should be noted that in the accompanying drawings, like elements are indicated by the same reference numerals as much as possible. In addition, detailed descriptions of well-known functions and configurations that may obscure the gist of the disclosed technology will be omitted. For the same reason, in the accompanying drawings, some components are exaggerated, omitted, or schematically illustrated, and the size of each component does not entirely reflect actual size.

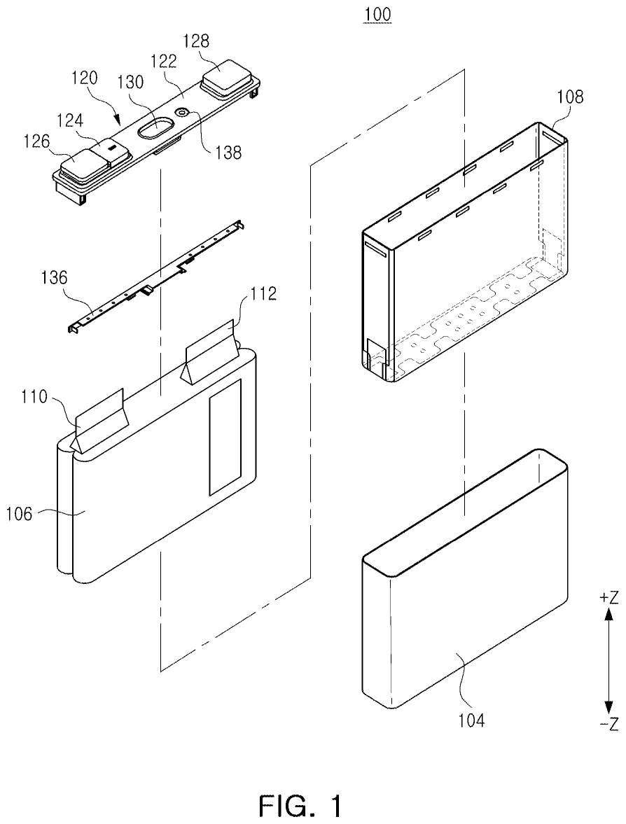

FIG. 1 is an exploded perspective view of a battery cell according to an embodiment.

Referring to FIG. 1, a battery cell 100 may be a prismatic cell. Prismatic cells are widely used in powertrains of electric vehicles. The prismatic cells may be stacked together in a rectangular shape, allowing more efficient use of space. Prismatic cells are generally rectangular and have a higher power density than cylindrical cells. Prismatic cells also provide better performance in cold weather and less damage from vibration. However, prismatic cells may be more expensive to manufacture than cylindrical cells. In addition, prismatic cells are less likely to fail due to vibration or movement. Prismatic cells may deliver more power than cylindrical battery cells due to spatial optimization of the rectangular shape thereof.

The prismatic battery cell 100 includes a rectangular can 104 that may be formed of steel, aluminum, aluminum alloy, plastic, or other metals having sufficient structural strength. The can 104 may be manufactured according to various different methods including deep draw or impact extrusion. The method for manufacturing the can 104 may be combined with wall ironing to achieve the final geometry, thickness and tolerances. The can 104 may be wrapped with cell cover tape.

A jelly roll 106 includes a stacked anode, cathode and separator. A jelly roll 106 type electrode assembly configured to have a structure of a long sheet type cathode and a long sheet type anode to which an active material is applied is wound. At the same time, the stacked-type electrode assembly has a structure in which a separator is disposed between a cathode and an anode or has a structure in which a plurality of cathodes and anodes having a predetermined size are sequentially stacked and a separator disposed between each of the cathodes and the anode. The jelly roll-type electrode assembly is easy to manufacture and has high unit mass and energy density, compared to a sheet-type electrode assembly. In some batteries, one or more jelly rolls 106 are inserted into can 104. Each jelly roll (electrode assembly) 106 is inserted inside the can 104 while being accommodated in a polymer jelly roll bag 108 or wrapped in a jelly roll sealing tape.

Each jelly roll 106 includes a cathode foil 112 formed of aluminum. The aluminum foil is coated with the electrode slurry. A first operation of electrode manufacturing is a slurry mixing process in which an active raw material is combined with a binder, a solvent and an additive. This mixing process should be performed separately for anode and cathode slurries. Viscosity, density, solids content and other measurable properties of the slurry affect battery quality and electrode uniformity. For example, a slurry having a faster drying rate, a higher solids content, a lower rate capability, and a low viscosity is generated as a solvent content is higher. Thereafter, the cathode slurry is applied to an aluminum foil and dried. A slot die coater is a method of coating a foil in which a slurry is spread through slot gaps on the moving foil receiving tension over rollers. In some embodiments, this may be performed simultaneously on both sides of the foil. This production method enables high speed, while achieving precision in coating thickness. A drying process may be incorporated into a continuous coating. The drying process should achieve three objectives: diffusion of the binder, sedimentation of particles, and evaporation of the solvent. Air floatation is a method of drying the slurry on the foil. Uniformity of the electrode coating and drying process affects the safety, consistency and life cycle of the prismatic battery cell 100. The electrode should go through a calendering process in which electrode porosity and twist are controlled by compressing the coated electrode sheet to a uniform thickness and density.

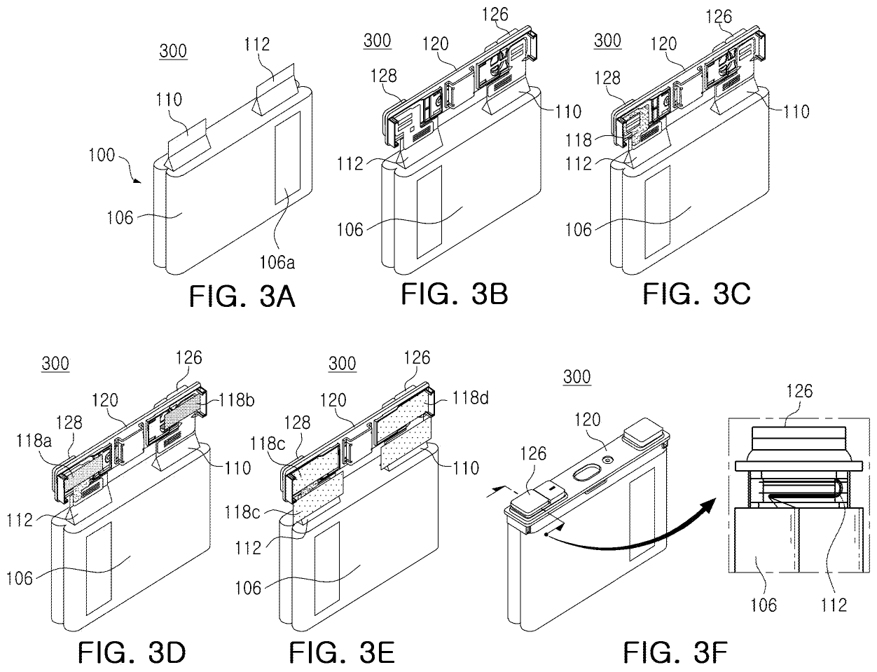

Each jelly roll 106 includes an anode foil 110 formed of copper foil. The anode foil 110 is provided similarly to a cathode foil 112. Each jelly roll 106 may include a cathode connector (not shown) that makes an electrical connection between the inner end portion of the cathode foil 112 and the cathode terminal 128. Each jelly roll 106 may include an anode connector (not shown) that makes an electrical connection between the inner end portion of the anode foil 110 and an anode terminal 126. Each jelly roll 106 may include a cathode connector mask (e.g., a cathode connector mask 118 in FIG. 3C).

Each prismatic battery cell 100 may have a top cap assembly (upper cap assembly) 120 welded or otherwise bonded to the top of the can 104. The top cap assembly 120 may include a base plate 122 attached to the can 104. The base plate 122 isolates the inside and outside of the cell by welding with the can 104. The base plate 122 may serve as a rigid support structure for elements within the top cap assembly 120. The top cap assembly 120 may include a plurality of top insulators 124 to insulate the base plate 122. The top insulator 124 may prevent leakage of an electrolyte from the prismatic battery cell 100. Additionally, the top insulator 124 may isolate the can 104 from the cathode foil 112 and prevent penetration of moisture and gases from the outside of the cell. A portion of the top insulator 124 may protect a current interrupting device. The top cap assembly 120 includes a cathode terminal 128 electrically connecting the inside and outside of the prismatic battery cell 100. The top cap assembly 120 includes an anode terminal 126 electrically connecting the inside and outside of the prismatic battery cell 100.

The top cap assembly 120 may include a vent cover 130 allowing exhaust gases from the prismatic battery cell 100 to be discharged in a controlled direction and at a controlled pressure. The top cap assembly 120 may include a vent guard 132 protecting the vent cover 130 from the inside of the prismatic battery cell 100 in order to prevent the vent cover 130 from malfunctioning. The top cap assembly 120 may include an overcharge safety device 134 preventing an external current from being introduced using an internal gas pressure of the prismatic battery cell 100. The top insulator 124 may be multi-component. In some embodiments, side portions of the top insulator 124 may be mounted on the edges of the can 104 and the top cap assembly 120. Once the prismatic battery cell 100 is configured, an electrolyte solution may be injected through an electrolyte injection port. An electrolyte cap 138 may close or seal the injection port.

The battery cell 100 may include an insulator 136 located between the top cap assembly 120 and the can 104. In this document, the electrode assembly of the battery cell 100 is described as the jelly roll 106, but the electrode assembly of the battery cell 100 is not limited to the jelly roll 106. For example, the jelly roll 106 may be replaced with a stack type electrode assembly or a Z-folding type electrode assembly. According to an embodiment, the jelly roll 106 described herein may refer to an electrode assembly.

In this document, the can 104 may be referred to as a case or housing.

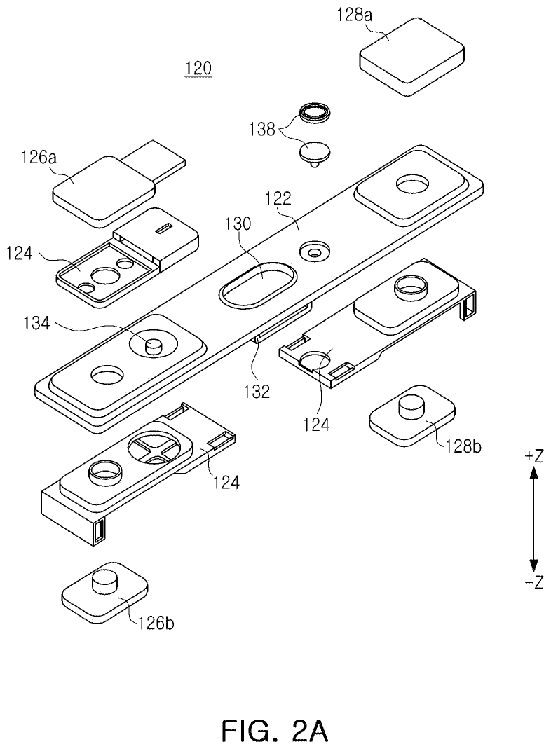

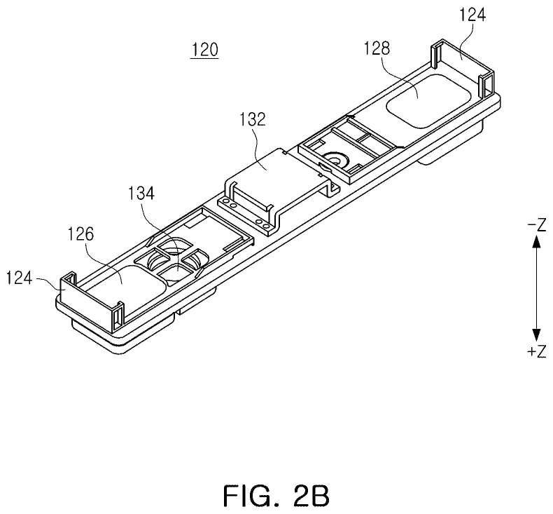

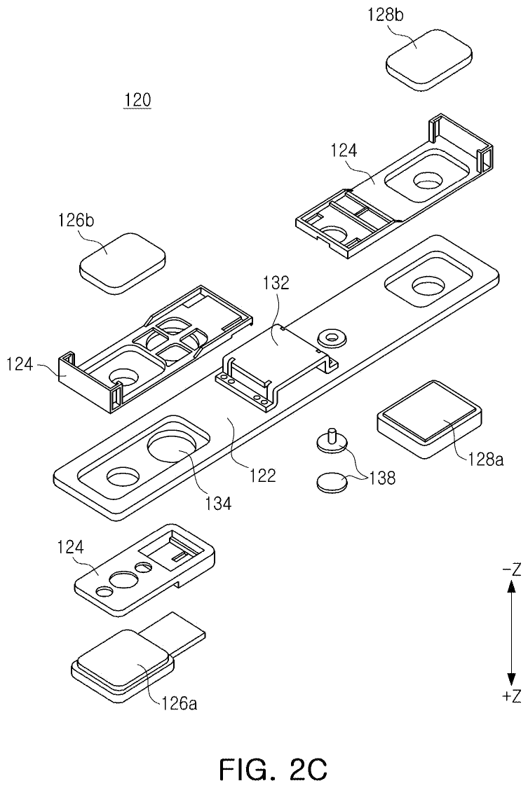

FIGS. 2A, 2B and 2C show a configuration and component functions of the top cap assembly 120. For example, FIG. 2A is an exploded perspective view of the top cap assembly 120 according to an embodiment of the present disclosure. FIG. 2B is a rear perspective view of the top cap assembly 120 according to an embodiment of the present disclosure. Description of the top cap assembly 120 of FIG. 1 may be applied to the top cap assembly 120 of FIGS. 2A, 2B and 2C.

The top cap assembly 120 serving as a cover for the prismatic battery cell 100 is a complex assembly including a plurality of welded components. Adhesives may be used instead of welding specific components.

The prismatic battery cell 100 may include the vent cover 130. The vent cover 130 provides overpressure alleviation when temperature and corresponding pressure increase in the prismatic battery cell 100. For example, the vent cover 130 may be activated in a preset pressure range. The vent cover 130 may be laser-welded to the top cap assembly 120.

The prismatic battery cell 100 may include the can 104. The can 104 may generally be formed of deep-drawn aluminum or stainless steel to prevent moisture from entering the cell, while providing diffusion resistance to organic solvents, such as liquid electrolytes. The most important reason the can 104 is typically formed of deep-drawn aluminum alloy or stainless steel is to reduce a welding point to improve the mechanical strength of the can 104. The electrolyte may be filled in the prismatic battery cell 100 through an injection port. After the electrolyte is filled, the injection port may be closed or sealed by an electrolyte cap 138. After electrolyte filling, the electrolyte cap 138 may be welded to the top cap assembly 120 or a locking ball (not shown) may be forced into the injection port. The cell may have an overcharge safety device 134 that may disconnect current flow when high internal pressure is reached in the prismatic battery cell 100. A rise in pressure is usually a result of high temperatures.

According to an embodiment, the cathode terminal 128 may be provided in plural. For example, the cathode terminal 128 may include a first cathode terminal 128a in which at least a portion is exposed to the outside of the battery cell 100 and a second cathode terminal 128b connected to a cathode foil (e.g., the cathode foil 112 of FIG. 1). The second cathode terminal 128b may be electrically connected to the first cathode terminal 128a. For example, a portion of the second cathode terminal 128b may contact the first cathode terminal 128a.

According to an embodiment, the anode terminal 126 may be provided in plural. For example, the anode terminal 126 may include a first anode terminal 126a in which at least a portion is exposed to the outside of the battery cell 100 and a second anode terminal 126b connected to an anode foil (e.g., the anode foil 110 of FIG. 1). The second anode terminal 126b may be electrically connected to the first anode terminal 126a. For example, a portion of the second anode terminal 126b may contact the first anode terminal 126a.

FIGS. 3A to 3F are a view illustrating an assembly process of a top cap assembly and an electrode assembly according to an embodiment. A battery cell manufacturing process 300 may include an assembly process of the top cap assembly 120 and the jelly roll 106.

Referring to FIG. 3A, a sealing tape 106a may be attached to the jelly roll 106. According to an embodiment, the sealing tape 106a can cover at least a portion of the jelly roll 106. According to an embodiment, the sealing tape 106a may seal a portion of the jelly roll 106.

Referring to FIG. 3B, the jelly roll 106 may be connected to the top cap assembly 120. For example, a connection component for connecting the jelly roll 106 and the top cap assembly 120 may be prepared. The top cap assembly 120 may be closely attached to the jelly roll 106 using the connection component. For example, the cathode terminal 128 of the top cap assembly 120 may be connected to the cathode foil 112 of the jelly roll 106, and the anode terminal 126 of the top cap assembly 120 may be connected to the jelly roll 106. The cathode terminal 128 may be welded to the cathode foil 112 and the anode terminal 126 may be welded (e.g., ultrasonic-welded) to the anode foil 110.

Referring to FIG. 3C, at least a portion of the cathode terminal 128 may be masked. For example, the cathode connector mask 118 may be disposed to cover a portion of the cathode terminal 128. The cathode connector mask 118 may protect the cathode terminal 128. Although not shown, the description of the masking of the cathode terminal 128 may be applied to the anode terminal 126 as well.

Referring to FIG. 3D and/or FIG. 3E, tape may be attached to at least a portion of the cathode terminal 128 and the anode terminal 126. For example, the battery cell 100 may include welding tapes 118a, 118b, 118c, and 118d attached to at least a portion of the cathode terminal 128, the anode terminal 126, the cathode foil 112, and/or the anode foil 110. According to an embodiment, the welding tapes 118a, 118b, 118c, 118d may be attached to at least a portion of a joint portion of the cathode terminal 128, the anode terminal 126, the cathode foil 112, and/or the anode foil 110. As the joint portion is covered with the welding tapes 118a, 118b, 118c, and 118d, the cathode terminal 128 and the anode terminal 126 may be protected.

Referring to FIG. 3F, the anode foil 110 connected to the anode terminal 126 may be folded. For example, when the top cap assembly 120 is disposed on the jelly roll 106, at least a portion of the anode foil 110 may be folded. Although not shown, when the top cap assembly 120 is placed on the jelly roll 106, the cathode foil 112 may also be folded.

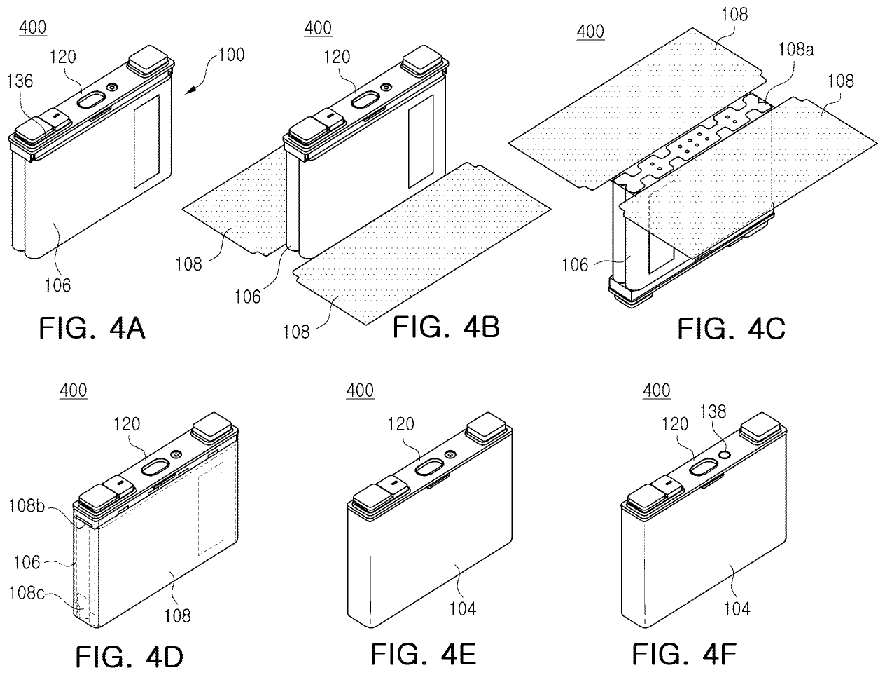

FIGS. 4A to 4F are a view illustrating an assembly process of an electrode assembly, a jelly roll bag, and a can. A battery cell manufacturing process 400 may include an assembly process of the jelly roll 106, the jelly roll bag 108, and the can 104.

Referring to FIG. 4A, an insulator 136 may be installed on the battery cell 100. For example, the insulator 136 may be disposed between the can 104 and the cap assembly 120.

Referring to FIG. 4B, the jelly roll bag 108 may be prepared. The jelly roll bag 108 may cover at least a portion (e.g., a side surface) of the jelly roll 106. The jelly roll 106 may be surrounded by the jelly roll bag 108. The jelly roll bag 108 may protect the jelly roll 106 from external impact. In FIG. 4B, a structure in which the jelly roll bag 108 is disposed on two side surfaces of the jelly roll 106 is shown, but the structure of the jelly roll bag 108 is not limited thereto. For example, according to an embodiment, the jelly roll bag 108 may be formed to cover four side surfaces of the jelly roll 106.

Referring to FIG. 4C, an insulator 108a may be attached to the jelly roll 106. According to an embodiment, in a state in which the jelly roll bag 108 is unfolded, the insulator 108a may be attached to a lower portion of the jelly roll 106. The insulator 108a may be referred to as a lower insulator.

Referring to FIG. 4D, at least some of the components of the battery cell 100 may be taped. For example, the battery cell 100 may include the top cap assembly 120, the can 104, and/or at least one first tape 108b attached onto insulator 136, and/or a second tape 108c attached to a lower portion of the jelly roll bag 108 along a side portion of the insulator 136.

Referring to FIG. 4E, the jelly roll 106 may be inserted into the can 104. The jelly roll 106 and/or the jelly roll bag 108 may be inserted into the can 104.

According to an embodiment, the battery cell manufacturing process 400 may include a wetting process of the jelly roll 106. For example, the jelly roll 106 may be initially wetted by an electrolyte delivered through an electrolyte injection port. For example, partial vacuum may be formed in the prismatic battery cell 100, and a predetermined amount of electrolyte may be injected through the electrolyte injection port. The partial vacuum may improve the distribution and wetting of all layers within the jelly roll 106. Wetting of all layers within the jelly roll 106 may require a rolling or spinning protocol to enhance wetting.

According to an embodiment, the battery cell manufacturing process 400 may include a quality check process for the initial wetting process, such as checking a weight of the prismatic battery cell 100 immediately after charging. For example, a second electrolyte charging operation in which an electrolyte is charged to achieve a desired weight may be applied to the battery cell. According to an embodiment, the battery cell manufacturing process 400 may include a pre-formation process of charging the prismatic battery cell 100 and discharging gas.

Referring to FIG. 4F, the electrolyte injection port may be sealed. For example, the electrolyte cap 138 may be inserted into the electrolyte injection port.

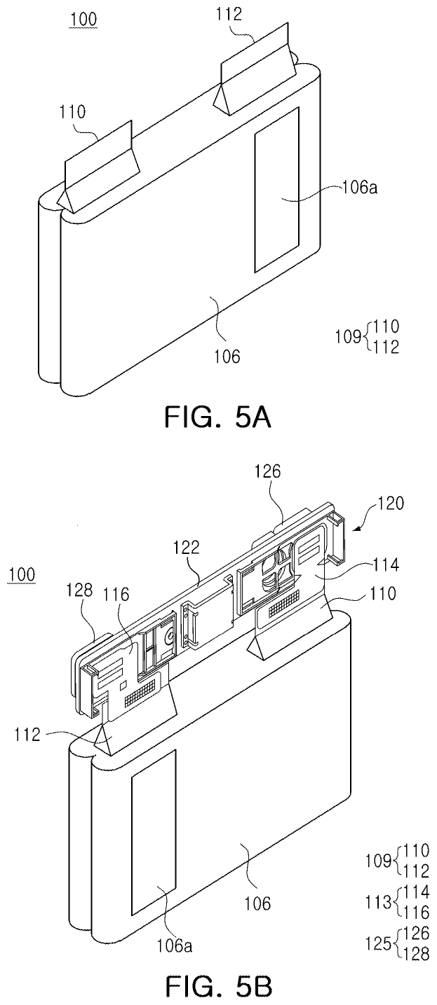

FIG. 5A is a perspective view of an electrode assembly 106 including an electrode foil 109, according to one embodiment. FIG. 5B is a perspective view illustrating a connection between an electrode foil 109 and an electrode terminal 125 on a top cap assembly 120, according to one embodiment.

Referring to FIGS. 5A and 5B, a battery cell 100 may include jelly roll 106 and/or top cap assembly 120. The jelly roll 106 may be an example of an electrode assembly. Hereinafter, in this document and claims, the electrode assembly will be described using a jelly roll as an example, and is denoted by the same reference numeral “106.”

FIG. 5A is a perspective view of an electrode assembly 106 including an electrode foil 109. The electrode foil 109 may include an anode foil 110 and a cathode foil 112. A sealing tape 106a, covering at least a portion of the electrode assembly 106, may be affixed to an outer surface of the electrode assembly 106.

FIG. 5B is a perspective view illustrating a connection between the electrode foil 109 and the electrode terminal 125 on a top cap assembly 120. The top cap assembly 120 may include a cap plate 122 and the electrode terminal 125. The electrode terminal 125 may include an anode terminal 126 and a cathode terminal 128. The electrode terminal 125 may be connected to the electrode foil 109. For example, the cathode foil 112 may be electrically connected to the cathode terminal 128, and the anode foil 110 may be electrically connected to the anode terminal 126. The electrode terminal 125 may be connected to the electrode foil 109 through a current collector 113. The current collector 113 may include an anode connector 114 and a cathode connector 116. The anode foil 110 may be connected to the anode terminal 126 (for example, the second anode terminal 126b in FIG. 2C) through the anode connector 114. The anode foil 110 and the anode connector 114 may be coupled to each other by welding (for example, ultrasonic welding or the like). The cathode foil 112 may be connected to the cathode terminal 128 (for example, the second cathode terminal 128b in FIG. 2C) through the cathode connector 116. The cathode foil 112 and the cathode connector 116 may be coupled to each other by welding (for example, ultrasonic welding or the like).

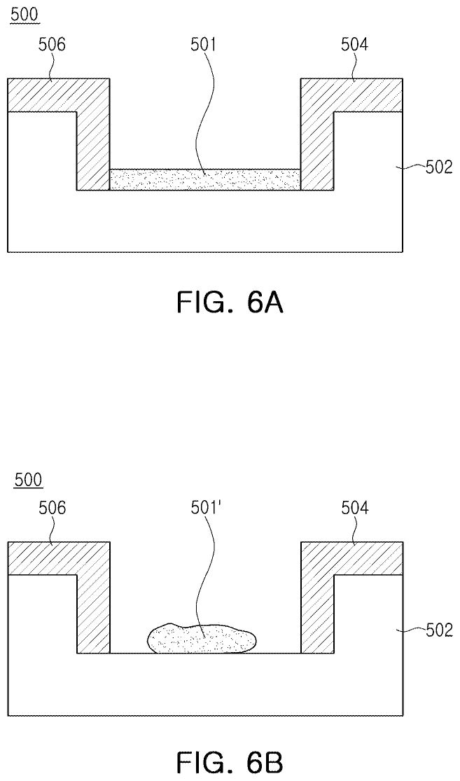

FIGS. 6A and 6B are schematic views illustrating a function of a thermal fuse, wherein FIG. 6A is a schematic view illustrating a conductive state of a thermal fuse and FIG. 6B is a schematic view illustrating a non-conductive state of the thermal fuse.

The thermal fuse 500 may include a non-resettable thermal fuse material 501 composed of an axisymmetric lead, a fusible alloy melting at a predefined temperature, a special compound to prevent melting or oxidation, and a ceramic insulator. The thermal fuse material 501 may work as a cutoff, a disposable (single-use) device which may not be reset once a predefined temperature threshold is exceeded. A special compound which may prevent melting before reaching a predefined temperature may be a resin mixture increasing the surface tension of the molten alloy, causing the molten alloy to be rapidly reduced or quickly shrinked towards a center thereof such that a ball shape permanently breaking the circuit may be formed. FIG. 6A illustrates a thermal fuse 500 in a conductive state. The thermal fuse material 501 may be seated on fuse carrier 502 and may form a conductive connection between a first conductor 504 and a second conductor 506. The thermal fuse 500 may remain in the state illustrated in FIG. 6A and may allow a current to travel from the first conductor 504 to the second conductor 506 up to a predefined temperature at which the thermal fuse material 501 melts. When the temperature threshold of the thermal fuse 500 is reached, the thermal fuse material 501 may be reduced to or contract into a ball shape illustrated in FIG. 6B. The triggered thermal fuse material 501′ may not conduct electricity between the first conductor 504 and the second conductor 506. In another embodiment, the thermal fuse material 501 may include a material which may boil off or blow up to break the current flow between the first conductor 504 and the second conductor 506. In “Characteristics of Thermal Runaway Propagation of Lithium-Ion Battery Module Induces by Thermal Abuses in Enclosed Space” by Caixing Chen et al., the authors note, “An exothermic reaction (temperature increase rate greater than 0.02 degrees C./min) was observed at 86.3 degrees C. because of the decomposition of the SEI layer on the surface of the anode.” Considering this, it may be reasonable to determine an activation threshold for the thermal fuse 500 at or below 80° C.

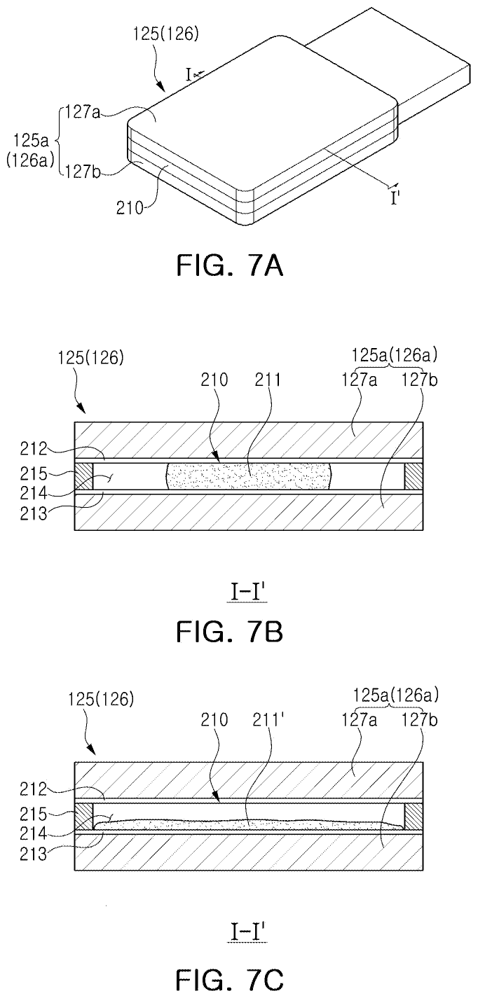

FIGS. 7A, 7B, and 7C illustrate a thermal fuse 210 integrated into an electrode terminal 125, wherein FIG. 7A is a perspective view illustrating an electrode terminal 125, FIGS. 7B and 7C are cross-sectional views taken along line I-I′ in FIG. 7A, illustrating a conductive state and a non-conductive state of the thermal fuse 210, respectively.

As illustrated in FIGS. 7A and 7B, the thermal fuse 210 may be integrated with the electrode terminal 125. The electrode terminal 125 may have a space in which the thermal fuse 210 is installed. The thermal fuse 210 may be coupled to the electrode terminal 125 and may be configured to be deformable at a set temperature (or a critical temperature) or higher. The thermal fuse 210 may be deformed in shape or appearance. For example, the thermal fuse 210 may be melted, boiled off or blown up at a set temperature or higher. The thermal fuse 210 may block a current flow between the electrode terminal 125 and outside of the battery cell at a set temperature or higher. The thermal fuse 210 and the electrode terminal 125 may be integrally coupled to each other by welding.

The electrode terminal 125 may include a first terminal body 125a of which at least a portion is exposed externally of the battery cell 100. The first terminal body 125a may include a first plate 127a and a second plate 127b which may be electrically conductive. The thermal fuse 210 may be integrated into the first terminal body 125a or may be integrally coupled to the first terminal body 125a. For example, the thermal fuse 210 may be disposed between the first plate 127a and the second plate 127b of the first terminal body 125a.

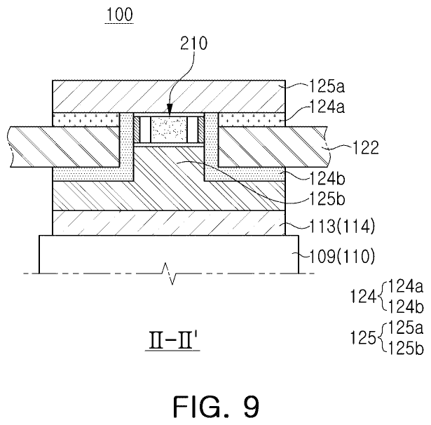

FIGS. 7A to 7C illustrate a configuration in which the thermal fuse 210 is installed in the first anode terminal 126a of the anode terminal 126, but the arrangement position or the coupling structure of the thermal fuse 210 may be varied. For example, the thermal fuse 210 may be integrated into the second anode terminal (126b in FIG. 2A) or may be integrally coupled to the second anode terminal 126b, and as illustrated in FIG. 9, the thermal fuse 210 may be disposed between the first anode terminal 126a and the second anode terminal 126b, Also, a thermal fuse 210 may be installed on a cathode terminal.

The thermal fuse 210 may correspond to the thermal fuse 500 described in FIGS. 6A and 6B. As illustrated in FIG. 7B, the thermal fuse 210 may include a first portion 211 including a thermal fuse material. The thermal fuse material may be deformed at a set temperature or higher. For example, the thermal fuse material provided to the first portion 211 may include at least one of a material that melts at a set temperature or higher, a material that boils off at a set temperature or higher, and a material that blows up at a set temperature or higher. The thermal fuse material may be modified to block a current flow at a set temperature or higher. The range of temperature blocking the current flow may be changed depending on the type or characteristics of the thermal fuse material. Accordingly, the type or characteristics of the thermal fuse material may be selected such that the thermal fuse 210 may operate in a specific temperature range corresponding to thermal runaway of the battery cell 100.

The thermal fuse 210 may include a second portion 212 and a third portion 213 disposed on both sides of the first portion 211 with respect to a direction in which current flows. The second portion 212 may be disposed in a direction toward the outside of the electrode terminal 125, and the third portion 213 may be disposed in a direction toward the electrode assembly. In this case, the third portion 213, the first portion 211 and the second portion 212 may be connected in series in order. The second portion 212 and third portion 213 may be electrically conductive. The second portion 212 of the thermal fuse 210 may be coupled to the first plate 127a by welding, and the third portion 213 may be coupled to the second plate 127b by welding.

At least a portion of a side surface of the thermal fuse 210 may include a non-conductive side surface 215. The non-conductive side surface 215 may be disposed around the first portion 211 and may have a shape surrounding a side surface of the first portion 211. A space 214 in which the first portion 211 is disposed may be formed between the second portion 212 and the third portion 213, and the non-conductive side surface 215 may have a shape surrounding a circumference of the space 214. The non-conductive side surface 215 may be disposed on edges of the second portion 212 and the third portion 213 and may connect the second portion 212 to the third portion 213. The non-conductive side surface 215 may cut off an electrical connection between the second portion 212 to the third portion 213. The non-conductive side surface 215 may be formed of plastic, polymer, resin or other non-conductive material. The non-conductive side surface 215 may control an electrical circuit to be completed through the first portion 211 of the thermal fuse 210. For example, a current between the second portion 212 and the third portion 213 may flow through the first portion 211 and may not flow through the non-conductive layer 215. Accordingly, when the current flow in the first portion 211 is blocked due to the temperature increase, no current may flow between the second portion 212 and the third portion 213.

When the electrode terminal 125 exceeds a set temperature or a critical temperature of the thermal fuse 210, as illustrated in FIG. 7C, the first portion 211′ of the thermal fuse 210 may be changed or deformed to have a non-conductive state. For example, the first portion 211′ may be melted at a set temperature or a critical temperature or higher and may be deformed into a shape mainly formed in a portion below the space 214. The non-conductive first portion 211′ may disconnect electrical connection between the second portion 212 and the second portion 213, and accordingly, a current flow between the first plate 127a and the second plate 127b may be blocked. Accordingly, the thermal fuse 210 may block a current flow between the electrode terminal 125 and the outside at a set temperature or higher.

Meanwhile, in FIGS. 7B and 7C, an embodiment in which the second portion 212 and the third portion 213 are disposed on both sides of the first portion 211 has been described, but the thermal fuse 210 may not include at least one of the second portion 212 and the third portion 213. In this case, the first portion 211 may be directly coupled to the first plate 127a and/or the second plate 127b. Also, the non-conductive side surface 215 may also be directly coupled to the first plate 127a and/or the second plate 127b.

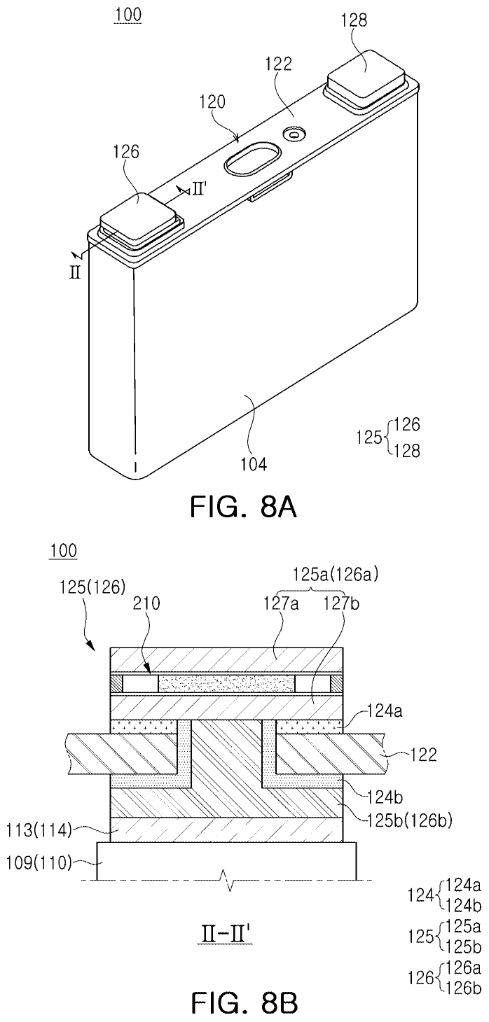

FIG. 8A is a perspective view illustrating a battery cell 100 according to one embodiment. FIG. 8B is a cross-sectional view taken along line II-II′ in FIG. 8A.

As illustrated in FIG. 8A, the battery cell 100 may include a case 104 accommodating an electrode assembly and a top cap assembly 120 covering the case 104. An electrode terminal 125 may be disposed on the cap plate 122 of the top cap assembly 120. The electrode terminal 125 may include an anode terminal 126 and a cathode terminal 128.

FIG. 8B illustrates a cross-section of a thermal fuse 210 installed in a battery cell 100, and internal components of the battery cell 100 are illustrated with reference to the battery cells illustrated in FIGS. 1 to 5B.

The battery cell 100 may include an electrode terminal 125 electrically connected to the electrode foil 109. The electrode terminal 125 may be disposed in and outside the case (104 in FIGS. 1 and 8A) through the cap plate 122. For example, a portion of the electrode terminal 125 may be disposed below the cap plate 122 to oppose the electrode foil 109, and another portion of the electrode terminal 125 may have a structure exposed externally of the cap plate 122. The electrode terminal 125 may have a divided structure to be disposed in a state of penetrating through the cap plate 122. For example, the electrode terminal 125 may include a first terminal body 125a having at least a portion disposed externally of the case and a second terminal body 125b having at least a portion disposed in the case 104. The first terminal body 125a and the second terminal body 125b may be coupled to the cap plate 122 while being separated from each other. The first terminal body 125a may be provided for electrical connection with an external entity, and the second terminal body 125b may be provided for electrical connection with the electrode foil 109. The second terminal body 125b and the electrode foil 109 may be electrically connected to each other through the current collector 113. In this case, the current collector 113 may be coupled to the electrode foil 109 on one side and may be coupled to the electrode terminal 125 on the other side.

An insulating member (upper insulator) 124 may be disposed between the electrode terminal 125 and the cap plate 122 for electrical insulation. The insulating member 124 may include a first insulating member 124a insulating between the upper surface of the cap plate 122 and the electrode terminal 125 and a second insulating member 124b insulating between a lower surface of the cap plate 122 and the electrode terminal 125. However, when the cap plate 122 has a structure having a polarity, one of the anode terminal 126 and the cathode terminal 128 may not include at least one of the first insulating member 124a and the second insulating member 124b.

A thermal fuse 210 may be coupled to the electrode terminal 125. A thermal fuse 210 may be coupled to the anode terminal 126. The anode terminal 126 may include a first anode terminal 126a having at least a portion thereof exposed externally of the battery cell 100 and a second anode terminal 126b connected to the anode foil 110. The anode foil 110 and the second anode terminal 126b may be connected by an anode connector 114. FIG. 8B illustrates the anode terminal 126 among the electrode terminals 125, but the cross-sectional structure in FIG. 8B may also be applied to the cathode terminal 128.

The thermal fuse 210 may be integrated into the first terminal body 125a or may be integrally formed with the first terminal body 125a. For example, the thermal fuse 210 may be disposed between the first plate 127a and the second plate 127b of the first terminal body 125a.

When the battery cell is charged and/or discharged at a set temperature (a critical temperature) or higher, the battery cell may be overheated, such that the battery cell may swell or may blow up, or there may be a risk of fire. General battery cells may include safety components such as a transistor to prevent overcurrent caused by overdischarging, overcharging, and short circuiting. However, general battery cells may have limitations in coping with the event in which the cause of the increase in internal temperature of the battery cell is not due to overcurrent. That is, general battery cells may not effectively solve issues caused by overheating of battery cells. However, in the embodiments, since the thermal fuse 210 operates at a temperature increase of a battery cell, issues caused by overheating may be effectively addressed. Also, since a temperature increase due to heat generation occurs even when an overcurrent occurs in the battery cell, the thermal fuse 210 may block a current flowing in the battery cell regardless of the cause of the temperature increase of the battery cell. Accordingly, according to the embodiment, overheating may be stably addressed.

FIG. 9 is a cross-sectional view illustrating a battery cell 100 illustrating a modified example in FIG. 8B.

In the example of the battery cell 100 illustrated in FIG. 9, the arrangement position of the thermal fuse 210 may be changed, differently from the battery cell illustrated in FIG. 8B.

As illustrated in FIG. 9, the electrode terminal 125 may include a first terminal body 125a and a second terminal body 125b, and a thermal fuse 210 may be disposed between the first terminal body 125a and the second terminal body 125b. The thermal fuse 210 may be coupled to at least one of the first terminal body 125a and the second terminal body 125b by welding. The thermal fuse 210 may cut off the electrical connection between the first terminal body 125a and the second terminal body 125b at a set temperature (or a critical temperature) or higher.

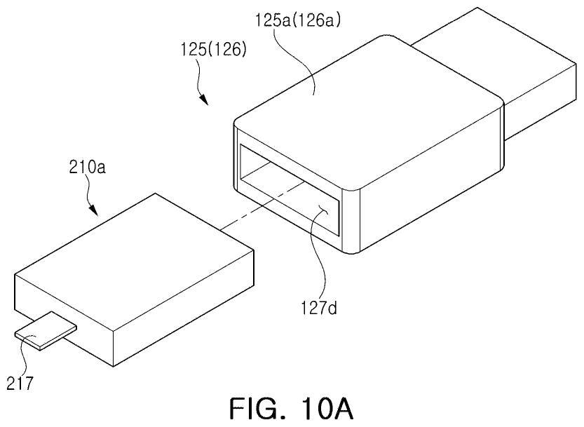

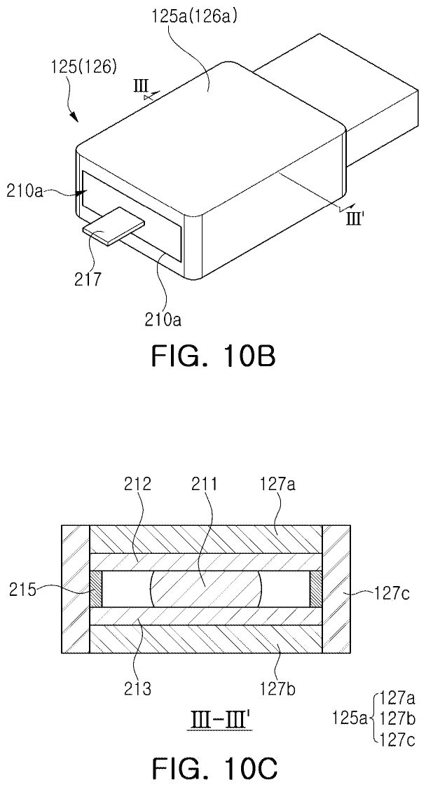

FIGS. 10A, 10B and 10C illustrate a replaceable thermal fuse 210a, wherein FIG. 10A is a perspective view illustrating a state before the replaceable thermal fuse 210a is coupled to an electrode terminal 125, FIG. 10B is a perspective view illustrating a state in which the replaceable thermal fuse 210a is coupled to the electrode terminal 125, and FIG. 10C is a cross-sectional view taken along line III-III′ in FIG. 10B.

Referring to FIGS. 10A and 10B, the electrode terminal 125 may include a terminal body 125a of which at least a portion is disposed externally of the case (104 in FIG. 8A). The thermal fuse 210a may be installed in the terminal body 125a of the electrode terminal 125 to be detached therefrom. The terminal body 125a may include a fuse accommodating space 127d in which the thermal fuse 210a may be accommodated, and the replaceable thermal fuse 210a may be accommodated in the fuse accommodating space 127d. The fuse accommodating space 127d may have a shape in which one side is open such that the thermal fuse 210a may be inserted. In order to ensure electrical connection between the thermal fuse 210a and the terminal body 125a in a state in which the thermal fuse 210a is inserted, the thermal fuse 210a may be inserted into the fuse accommodating space 127d in a compressed state. For example, a level (height) of the fuse accommodating space 127d may have a value smaller than a level (height) of the thermal fuse 210a. The fuse accommodating space 127d may have a shape of a coin slot.

The replaceable thermal fuse 210a may include a handle 217 to be removable. The handle 217 may be specified on the end of a custom tool to ensure that the handle 217 is only serviced by certified technicians.

FIGS. 10A and 10B illustrate a configuration in which a replaceable thermal fuse 210a is integrated into an anode terminal 126 among electrode terminals 125, but the replaceable thermal fuse 210a may also be applied to the cathode terminal 128.

Referring to FIG. 10C, a terminal body 125a may include a first plate 127a and a second plate 127b spaced apart from the first plate 127a. A fuse accommodating space (217d in FIG. 10A) accommodating the thermal fuse 210a may be formed between the first plate 127a and the second plate 127b. The first plate 127a and the second plate 127b may be electrically conductive.

The terminal body 125a may further include a plurality of side plates 127c connecting the first plate 127a to the second plate 127b. To avoid a short circuit, a plurality of side plates 127c may be non-conductive. The plurality of side plates 127c may insulate between the first plate 127a and the second plate 127b. The replaceable thermal fuse 210a may have a cross-sectional structure described with reference to FIGS. 7B and 7C.

When the electrode terminal 125 exceeds a set temperature (or a critical temperature), the first portion 211 of the thermal fuse 210a may be deformed to a state as illustrated in FIG. 7C and may cut off electrical connection between the first plate 127a and the second plate 127b. In this case, the replaceable thermal fuse 210a may be separated from the electrode terminal 125 as illustrated in FIG. 10A. Thereafter, a new thermal fuse 210a may be installed in the fuse accommodating space 217d of the terminal body 125a and may activate the battery cell again.

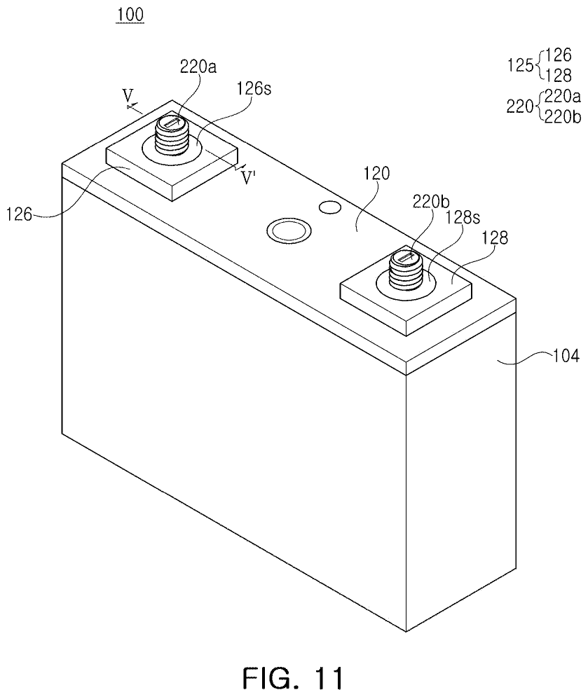

FIG. 11 is a perspective view illustrating a structure in which a connector-type thermal fuse 220a is coupled to an electrode terminal of a battery cell according to one embodiment.

The battery cell 100 may include a case 104 and a top cap assembly 120, and the top cap assembly 120 may include a cap plate 122 and an electrode terminal 125 exposed externally of the cap plate 122. The battery cell 100 may include a connector-type thermal fuse 220 for electrically connecting the electrode terminal 125 externally of the battery cell 100. The connector-type thermal fuse 220 may be manufactured in a state of being separated from the electrode terminal 125 and may be coupled to the electrode terminal 125, but may also be integrally formed with the electrode terminal 125. Also, the connector-type thermal fuse 220 may have a bolt (screw) shape and also a nut shape. An anode connector-type thermal fuse 220a may be connected to the anode terminal 126, and a cathode connector-type thermal fuse 220b may be connected to the cathode terminal 128.

The connector-type thermal fuse 220 may include a threaded screw-type connector. A lower side portion of the connector-type thermal fuse 220 may be connected to the electrode terminal 125 through screw-coupling. An upper side portion of the connector-type thermal fuse 220 may be coupled to a nut-type external connector for electrical connection with an external circuit such as a busbar. The anode terminal screw stop 126s may be disposed on an upper surface of the anode terminal 126. The anode terminal screw stop 126s may set a position (level) at which the nut-type external connector is fixed. A non-conductive insulating member may be disposed between the anode terminal screw stop 126s and the upper surface of the anode terminal 126 such that the anode terminal 126 and the nut-type external connector may not be directly electrically connected to each other. Similarly, a cathode terminal screw stop 128s may be disposed on an upper surface of cathode terminal 128. The cathode terminal screw stop 128s may set a position (level) at which the nut-type external connector is fixed. A non-conductive insulating member may be disposed between the cathode terminal screw stop 128s and an upper surface of the cathode terminal 128 such that the cathode terminal 128 and the nut-type external connector may not be directly electrically connected to each other. In an embodiment, at least one of the anode connector-type thermal fuse 220a and the cathode connector-type thermal fuse 220b may be separated from the anode terminal 126 or the cathode terminal 128.

Alternatively, the connector-type thermal fuse 220 may be attached to the electrode terminal 125 through welding. For example, an anode connector-type thermal fuse 220a may be attached to the anode terminal 126 through ultrasonic welding. Similarly, the cathode connector-type thermal fuse 220b may be attached to the cathode terminal 128 through ultrasonic welding.

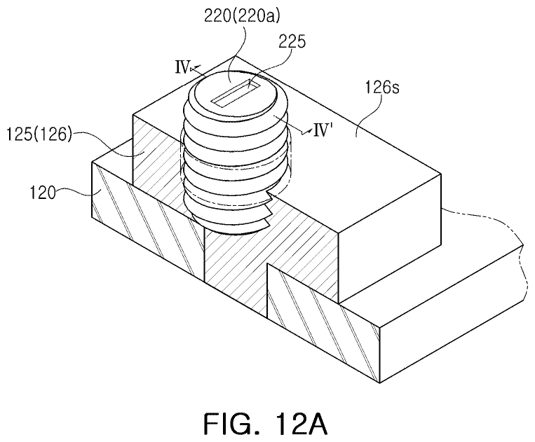

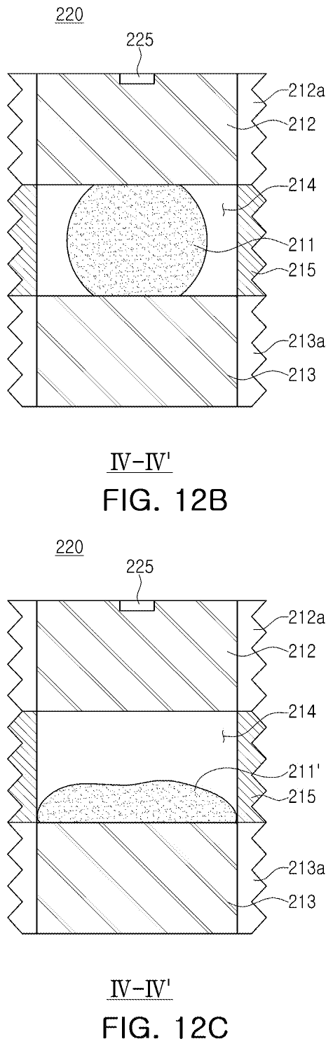

FIG. 12A is a partially cut-away perspective view schematically illustrating a portion in which an electrode terminal 125 and a connector-type thermal fuse 220 are coupled to each other in FIG. 11. FIGS. 12B and 12C are cross-sectional views taken along the line IV-IV′ in FIG. 12A, each illustrating a conductive state and a non-conductive state of a connector-type thermal fuse.

Referring to FIG. 12A, the electrode terminal 125 may be installed to penetrate through the cap plate 122 of the top cap assembly 120. A portion of the electrode terminal 125 may have a state of being exposed to the external surface of the cap plate 122. The thermal fuse may be provided as a connector-type thermal fuse 220 coupled to the electrode terminal 125 to supply a current from the electrode terminal 125 externally. The connector-type thermal fuse 220 may include a thread formed on at least a portion of a side surface. The anode terminal screw stop 126s may limit a position in which the nut-type external connector is coupled when the nut-type external connector is coupled to the connector-type thermal fuse 220. A tool fastening groove 225 may be formed on an upper surface of the connector-type thermal fuse 220 to allow the connector-type thermal fuse 220 to be screwed into or separated from the electrode terminal 125. The tool fastening groove 225 may have a general screw type or, alternatively, may have a custom design requiring specific tools which may only be serviced by certified technicians. FIG. 12A illustrates the example in which the anode connector-type thermal fuse 220a is coupled to the anode terminal 126, but the connector-type thermal fuse 220 may also be coupled to the cathode terminal 128.

FIG. 12B illustrates a cross-section of a connector-type thermal fuse 220 in a conductive state. The connector-type thermal fuse 220 may include a first portion 211 including a thermal fuse material deformed (e.g., melted, boiled off, or blown up) at a set temperature or higher and blocking current. The thermal fuse material provided to the first portion 211 may include at least one of a material that melts at a set temperature or higher, a material that boils off, and a material that blows up.

The connector-type thermal fuse 210 may include a second portion 212 and a third portion 213 disposed on both sides of the first portion 211 with respect to a direction in which current flows. The second portion 212 and third portion 213 may be electrically conductive. The second portion 212 may electrically connect the first portion 211 to an external circuit, and the third portion 213 may electrically connect the first portion 211 to the electrode terminal 125. The third portion 213, the first portion 211 and the second portion 212 may be connected in series in order.

At least a portion of a side surface of the connector-type thermal fuse 220 may include a non-conductive side surface 215. The non-conductive side surface 215 may have a shape surrounding a side surface of the first portion 211. The non-conductive side surface 215 may be disposed between the side surface 212a of the second portion 212 and the side surface 213a of the third portion 213. The non-conductive side surface 215 may cut off an electrical connection between the second portion 212 to the third portion 213. The non-conductive side surface 215 may be formed of plastic, polymer, resin or other non-conductive material. The non-conductive side surface 215 may control an electrical circuit to be completed through the first portion 211 of the connector-type thermal fuse 220. For example, current between the second portion 212 and the third portion 213 flows through the first portion 211 and may not flow through the non-conductive side surface 215. Accordingly, when the thermal fuse material of the first portion 211 is deformed due to a temperature increase, current does not flow between the second portion 212 and the third portion 213. The non-conductive side surface 215 may have a threaded shape to enable screw-coupling.

The side surface 212a of the second portion 212 may be electrically conductive and may be formed of the same material as that of the body portion of the second portion 212. Similarly, the side surface 213a of the third portion 213 may be electrically conductive and may be formed of the same material as that of the body portion of the third portion 213. A side surface 212a of the second portion 212 and a side surface 213a of the third portion 213 may have threads.

FIG. 12C illustrates a cross-section of a connector-type thermal fuse 220 in a non-conductive state. As illustrated in FIG. 12C, when the connector-type thermal fuse 220 reaches a set temperature (a critical temperature) or higher, the thermal fuse material of the first portion 211′ may be deformed. Since the deformed first portion 211′ may be separated from the second portion 212, no current may flow between the second portion 212 and the third portion 213. Since the non-conductive side surface 215 may have electrical insulation, an electrical connection between the second portion 212 and the third portion 213 may be blocked, and accordingly, current flow between the electrode terminal 125 and the outside may be blocked.

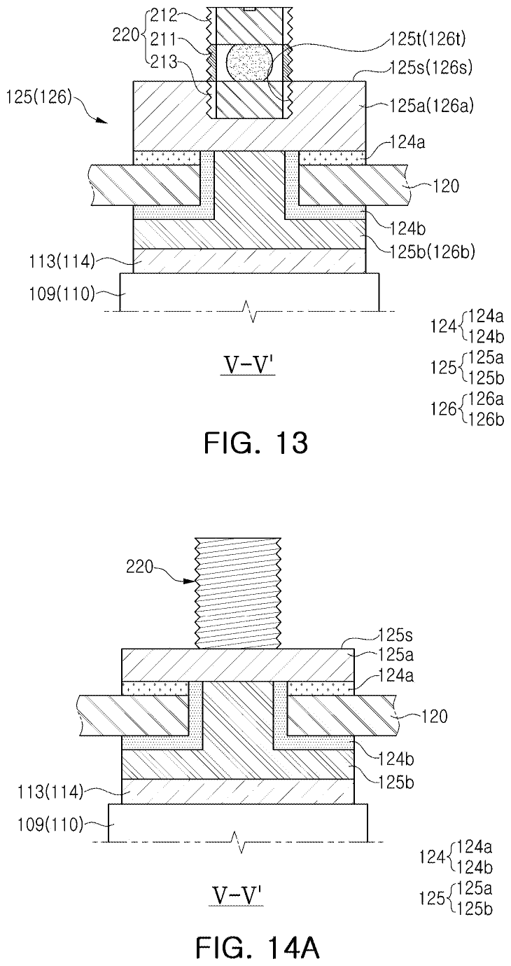

FIG. 13 is a cross-sectional view taken along the line V-V′ in FIG. 11.

FIG. 13 illustrates a cross-sectional shape similar to the examples in FIGS. 8B and 9, the region in which the connector-type thermal fuse 220 is installed may be different. A description of components similar to those in FIGS. 8B and 9 will not be provided and the connector-type thermal fuse 220 will be mainly described.

The second portion 212 of the connector-type thermal fuse 220 may be installed in a state of being exposed externally of the electrode terminal 125 such that the second portion 212 may be coupled to an external connector, and may be electrically conductive. A side surface of the second portion 212 may be threaded to be screwed into a nut-type external connector. However, depending on the shape or the coupling structure of the external connector connected to the second portion 212, the side surface of the second portion 212 may be non-conductive or may have a smooth surface.

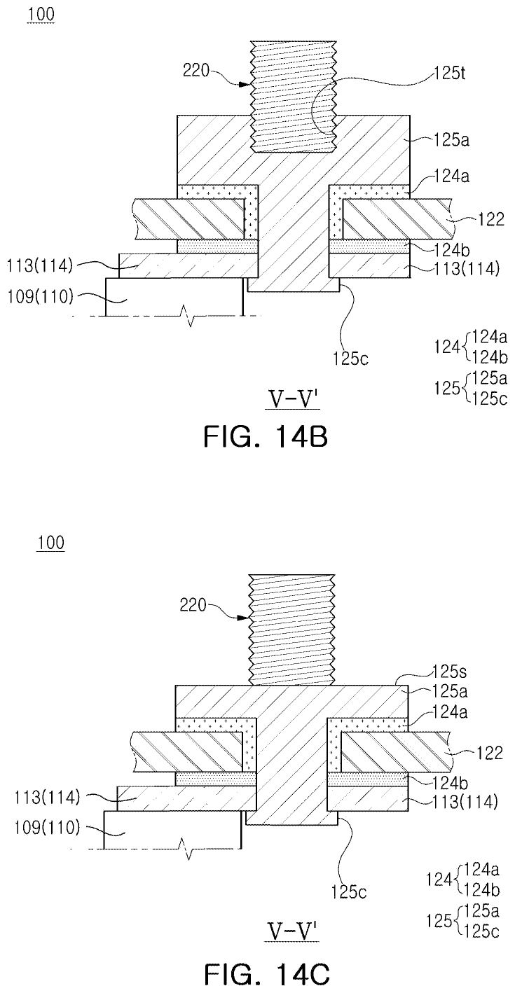

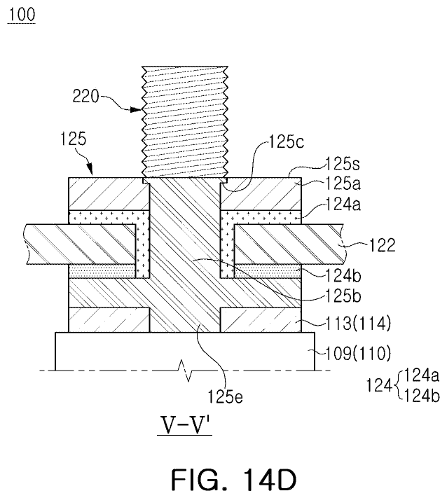

The third portion 213 of the connector-type thermal fuse 220 may be disposed in a recessed state in the electrode terminal 125 so as to be electrically connected to the electrode terminal 125, and may be electrically conductive. The electrode terminal 125 may include a coupling groove 125t into which the third portion 213 of the connector-type thermal fuse 220 is inserted. A thread may be formed on the side surface of the third portion 213 to be screwed to the electrode terminal 125. Alternatively, the third portion 213 may be welded to the electrode terminal 125 in a recessed state. However, depending on the shape or the coupling structure of the electrode terminal 125 connected to the third portion 213, the side surface of the third portion 213 may have a smooth surface. Also, the third portion 213 may be disposed to be attached to an external surface of the electrode terminal 125 (see FIGS. 14A and 14C).

Meanwhile, the terminal screw stop 125s may be disposed in a region corresponding to the first portion 211 of the connector-type thermal fuse 220 or a region corresponding to a boundary between the first portion 211 and the third portion 213. The terminal screw stop 125s may limit the position in which the nut-type external connector is coupled when the nut-type external connector is coupled to the connector-type thermal fuse 220. Accordingly, the electrode terminal 125 may be in contact with the third portion 213 and may not be in contact with the second portion 212. Accordingly, the electrode terminal 125 and the external circuit may be electrically connected to each other through the first portion 211 of the connector-type thermal fuse 220.

FIGS. 14A, 14B, 14C and 14D are cross-sectional views illustrating a modified example of the battery cell illustrated in FIG. 13.

The battery cell illustrated in FIG. 14A is different from the battery cell illustrated in FIG. 11 in that the battery cell may have a structure in which the connector-type thermal fuse 220 may be attached to an external surface of the electrode terminal 125. The connector-type thermal fuse 220 may be attached to an upper surface 125s of the electrode terminal 125 by welding.

As illustrated in FIGS. 14B and 14C, the electrode terminal 125 may include a single terminal body. The electrode terminal 125 may include a first terminal body 125a penetrating through the cap plate 122 and disposed above and below the cap plate 122. The electrode terminal 125 may be rivet-coupled below the cap plate 122. For example, the first terminal body 125a may be rivet-coupled while penetrating through the cap plate 122 and the current collector 113. The deformed portion 125c formed by rivet-coupled may have a diameter larger than the opening formed in the current collector 113 and may be formed below the current collector 113. As illustrated in FIG. 14B, a portion of the connector-type thermal fuse 220 may be connected to the electrode terminal 125 in a recessed state. Alternatively, as illustrated in FIG. 14C, the lower surface of the connector-type thermal fuse 220 may be attached to an upper surface 125s of the electrode terminal 125 by welding.

The battery cell illustrated in FIG. 14D illustrates an example in which the electrode terminal 125 is rivet-coupled on the outside of the cap plate 122. The electrode terminal 125 may include a first terminal body 125a disposed externally of the cap plate 122 and a second terminal body 125b disposed above and below the cap plate 122 by penetrating through the first terminal body 125a and the cap plate 122. The second terminal body 125b may include a protrusion 125e fitted to the current collector 113. The second terminal body 125b may be rivet-coupled above the cap plate 122. For example, the second terminal body 125b may be rivet-coupled while penetrating through the cap plate 122 and the first terminal body 125a. The deformed portion 125c formed by rivet-coupled may have a diameter larger than that of an opening formed in the first terminal body 125a and may be formed above the first terminal body 125a. The connector-type thermal fuse 220 may be attached to the upper surface 125s of the electrode terminal 125 by welding.

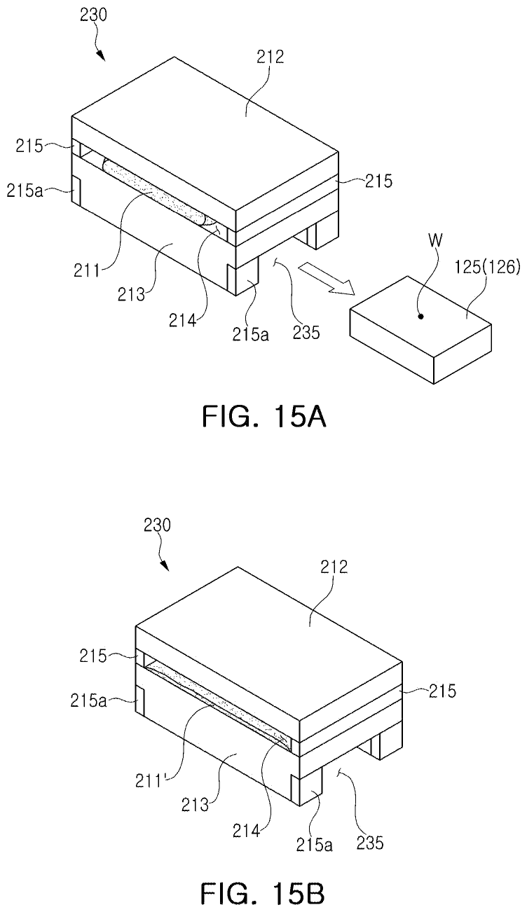

FIGS. 15A and 15B are schematic views illustrating a clamp-type thermal fuse 230 according to one embodiment, wherein FIG. 15A is a partially cut-away perspective view illustrating a state before the clamp-type thermal fuse 230 is coupled to an electrode terminal 125, and FIG. 15B is a partially cut-away perspective view illustrating a non-conductive state of a clamp-type thermal fuse in a state in which a clamp-type thermal fuse 230 and an electrode terminal 125 are coupled to each other. FIGS. 15A and 15B illustrate a shape in which a portion is cut out such that the internal structure of the first portions 211 and 211′ may be visual.

The battery cell according to the embodiment may include a clamp-type thermal fuse 230 for electrically connecting the electrode terminal 125 externally of the battery cell.

Referring to FIG. 15A, a clamp-type thermal fuse 230 may include a first portion 211 including at least one of a material that melts at a set temperature or higher, a material that boils off at a set temperature or higher, and a material that blows up at a set temperature or higher, a second portion 212 connecting the first portion 211 to an external circuit, and a third portion 213 connecting the first portion 211 to the electrode terminal 125. The second portion 212 and the third portion 213 may be electrically conductive and may be electrically connected to each other by the first portion 211 including a thermal fuse material.

The third portion 213 may include a space 235 accommodating the electrode terminal 125 to clamp the electrode terminal 125. The clamp-type thermal fuse 230 may clamp the electrode terminal 125 through the third portion 213 and may allow the third portion 213 and the electrode terminal 125 to be electrically connected to each other. The clamp-type thermal fuse 230 may include a non-conductive side surface 215 disposed around the first portion 211 to connect the second portion 212 to the third portion 213. The non-conductive side surface 215 may cut off an electrical connection between the second portion 212 to the third portion 213. The third portion 213 of the clamp-type thermal fuse 230 may include a non-conductive region 215a in a portion not in contact with the electrode terminal 125. The electrode terminal 125 may be welded or bonded to the clamp-type thermal fuse 230 through an attachment point (W).

FIG. 15B illustrates a cross-section of a clamp-type thermal fuse 230 in a non-conductive state. As illustrated in FIG. 15B, when the clamp-type thermal fuse 230 reaches a set temperature (a critical temperature) or higher, the thermal fuse material of the first portion 211′ may be deformed. Since the deformed first portion 211′ is spaced apart from the second portion 212, no current may flow between the second portion 212 and the third portion 213. Since the non-conductive side surface 215 has electrical insulation, an electrical connection between the second portion 212 and the third portion 213 may be blocked, and accordingly, the current flow between the electrode terminal 125 and the outside may be blocked.

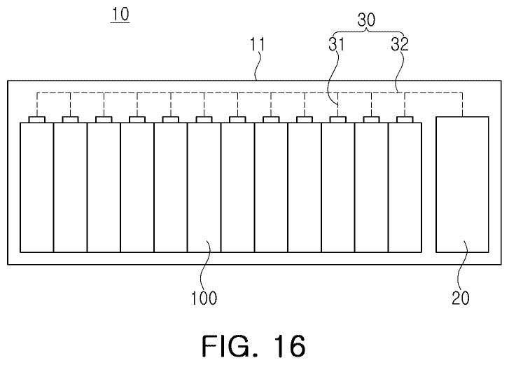

FIG. 16 is a schematic view illustrating a battery device according to one embodiment.

Referring to FIG. 16, a battery device 10 may include a plurality of battery cells 100, a housing 11 accommodating a plurality of battery cells, and a controller 20. The plurality of battery cells 100 may include battery cells including thermal fuses 210, 210a, 220, and 230 as described with reference to FIGS. 1 to 15. The thermal fuses 210, 210a, 220, and 230 may be coupled to the electrode terminal 125 and may be modified at a set temperature or higher. The thermal fuses 210, 210a, 220, and 230 may block the current flow between the electrode terminal 125 and the outside at a set temperature or higher.

The controller 20 may include a battery management system (BMS) or may be configured as a portion of a battery management system. The controller 20 may be connected to at least a portion of the plurality of battery cells 100 through a signal line 30. The signal line 30 may include a first line 31 connected to a plurality of battery cells and a second line 32 connected to the controller 20. The second line 32 may include a plurality of lines to sense an output voltage of a plurality of battery cells. When at least one of current and/or voltage is not sensed from at least one battery cell among the plurality of battery cells, the controller 20 may output an abnormal signal or may block or limit operation of at least a portion of the battery cells. For example, when at least one of the current and/or voltage is not sensed in at least a portion of the battery cell, the controller 20 may recognize that the temperature of the battery cell has reached a set temperature (a critical temperature) or higher. Accordingly, the controller 20 may perform a series of controls for delaying or blocking thermal runaway in the plurality of battery cells 100 disposed in the battery device 10. For example, the controller 20 may block or limit the use of a battery cell of which a temperature has risen in the plurality of battery cells disposed in the battery device 10 and neighboring battery cells. Also, the controller 20 may block or limit operation of the entirety of the plurality of battery cells disposed in the battery device 10.

Functions performed in a process and method may be implemented in a different order. In addition, outlined steps and operations may be only provided as examples, and some of the steps and operations may be optional, combined into fewer steps and operations, or expanded into additional steps and operations without detracting from the essence of the disclosed embodiments.

Only specific examples of implementations of certain embodiments are described. Variations, improvements and enhancements of the disclosed embodiments and other embodiments may be made based on the disclosure of this patent document.

In addition, the embodiment has been described using a prismatic battery cell as an example, but the embodiment may be applied to a cylindrical battery cell or a coin-type battery cell.

[DESCRIPTION OF REFERENCE CHARACTERS]

| | | | |
|---|---|---|---|
| 100 | BATTERY CELL | 106 | ELECTRODE ASSEMBLY |
| 122 | CAP PLATE | 125 | ELECTRODE TERMINAL |
| 210 | THERMAL FUSE | 211 | FIRST PORTION |
| 212 | SECOND PORTION | 213 | THIRD PORTION |
| 215 | NON-CONDUCTIVE | | |
| | LAYER | | |
| 220 | CONNECTOR-TYPE | | |
| | THERMAL FUSE | | |
| 230 | CLAMP-TYPE | | |
| | THERMAL FUSE | | |

What is claimed is:

1. A battery cell comprising:
A battery cell, comprising:
an electrode assembly including an electrode foil;
an electrode terminal electrically connected to the electrode foil; and
a thermal fuse coupled to the electrode terminal and deformable at a set temperature or higher,
wherein the thermal fuse is configured to block a current flow between the electrode terminal and outside of the battery cell at a set temperature or higher.

2. The battery cell of claim 1, wherein the thermal fuse includes a first portion including at least one of a material that melts at a set temperature or higher, a material that boils off at a set temperature or higher, and a material that blows up at a set temperature or higher.

3. The battery cell of claim 2,
wherein the thermal fuse further includes a second portion and a third portion disposed on both sides of the first portion with respect to a current flow direction, and
wherein the second portion and the third portion are electrically conductive.

4. The battery cell of claim 2, wherein the thermal fuse further includes a non-conductive side surface disposed around the first portion.

5. The battery cell of claim 1, wherein the thermal fuse is integrally coupled to the electrode terminal.

6. The battery cell of claim 5, further comprising:
a case accommodating the electrode assembly; and
a cap plate covering the case,
wherein the electrode terminal is disposed on the cap plate.

7. The battery cell of claim 6,
wherein the electrode terminal includes a first terminal body having at least a portion disposed externally of the case, and a second terminal body having at least a portion disposed in the case and electrically connecting the electrode foil to the first terminal body, and
wherein the thermal fuse is integrally coupled to at least one of the first terminal body and the second terminal body, or is disposed between the first terminal body and the second terminal body.

8. The battery cell of claim 6,
wherein the electrode terminal includes a terminal body of which at least a portion is disposed externally of the case, and
wherein the thermal fuse is installed to be detachable from the terminal body.

9. The battery cell of claim 8,
wherein the terminal body includes a first plate and a second plate spaced apart from the first plate, and includes a fuse accommodating space configured to accommodate the thermal fuse between the first plate and the second plate, and
wherein the first plate and the second plate are electrically conductive.

10. The battery cell of claim 9,
wherein the terminal body further includes a plurality of side plates connecting the first plate to the second plate, and
wherein the plurality of side plates are non-conductive.

11. The battery cell of claim 1, wherein the thermal fuse is provided as a connector-type thermal fuse coupled to the electrode terminal to supply a current from the electrode terminal externally.

12. The battery cell of claim 11,
wherein the connector-type thermal fuse includes a first portion including at least one of a material that melts at a set temperature or higher, a material that boils off at a set temperature or higher, and a material that blows up at a set temperature or higher, a second portion connecting the first portion to an external circuit, and a third portion connecting the first portion to the electrode terminal, and
wherein the second portion and the third portion are electrically conductive.

13. The battery cell of claim 12, wherein the connector-type thermal fuse further includes a non-conductive side surface disposed around the first portion to cut off an electrical connection between the second portion to the third portion.

14. The battery cell of claim 12,
wherein the second portion is exposed externally of the electrode terminal, and
wherein the third portion is disposed to be recessed into the electrode terminal or to be seated on an external surface of the electrode terminal.

15. The battery cell of claim 1, wherein the thermal fuse is provided as a clamp-type thermal fuse configured to clamp the electrode terminal to supply a current from the electrode terminal externally.

16. The battery cell of claim 15,
wherein the clamp-type thermal fuse includes a first portion including at least one of a material that melts at a set temperature or higher, a material that boils off at a set temperature or higher, and a material that blows up at a set temperature or higher, a second portion connecting the first portion to an external circuit, and a third portion connecting the first portion to the electrode terminal,
wherein the second portion and the third portion are electrically conductive, and
wherein the third portion includes a space for accommodating the electrode terminal to clamp the electrode terminal.

17. The battery cell of claim 16, wherein the clamp-type thermal fuse includes a non-conductive side surface disposed around the first portion to cut off an electrical connection between the second portion to the third portion.

18. The battery cell of claim 1, wherein the electrode terminal and the electrode foil are connected to each other by a current collector.

19. The battery cell of claim 1,
wherein the electrode terminal includes an anode terminal and a cathode terminal, and
wherein the thermal fuse is disposed on at least one of the anode terminal and the cathode terminal.

20. A battery device, comprising:
a plurality of battery cells;
a housing accommodating the plurality of battery cells; and
a controller connected to at least one of the plurality of battery cells,
wherein the plurality of battery cells include an electrode assembly including an electrode foil, an electrode terminal electrically connected to the electrode foil, and a thermal fuse coupled to the electrode terminal and deformable at a set temperature or higher,
wherein the thermal fuse is configured to block a current flow between the electrode terminal and outside of the plurality of battery cells at a set temperature or higher, and
wherein, when at least one of current and voltage is not sensed from at least one battery cell among the plurality of battery cells, the controller outputs an abnormal signal or blocks or limits operation of at least a portion of the battery cells.
